(19) United States
(12) Patent Application Publication
(10) Pub. No.: US 2024/0160930 A1
(43) Pub. Date: May 16, 2024

(54) MULTITASK LEARNING APPARATUS AND METHOD FOR HETEROGENEOUS SPARSE DATASETS

(71) Applicant: ELECTRONICS AND TELECOMMUNICATIONS RESEARCH INSTITUTE, Daejeon (KR)

(72) Inventor: Jiwon YANG, Daejeon (KR)

(73) Assignee: ELECTRONICS AND TELECOMMUNICATIONS RESEARCH INSTITUTE, Daejeon (KR)

(21) Appl. No.: 18/509,790

(22) Filed: Nov. 15, 2023

(30) Foreign Application Priority Data
Nov. 16, 2022 (KR) 10-2022-0153406
Oct. 26, 2023 (KR) 10-2023-0144354

(51) Int. Cl. G06N 3/08; G06N 3/04

(52) U.S. Cl. CPC G06N 3/08; G06N 3/04

(57) ABSTRACT

Provided are a multitask learning apparatus and method for improving learning performance of heterogeneous small datasets. The multitask learning apparatus includes a first layer configured to generate feature vectors by projecting training data pairs generated from different tasks to one feature space, a second layer configured to extract a common feature from the projected feature vectors, and a third layer configured to draw each individual inference from the extracted common feature. Here, the first layer and the third layer are task-specific layers, and the second layer is a layer shared between tasks. The first layer, the second layer, and the third layer perform forward propagation in one artificial neural network.

### CROSS-REFERENCE TO RELATED APPLICATIONS

This application claims priority to and the benefit of Korean Patent Applications No. 10-2022-0153406 filed on Nov. 16, 2022 and No. 10-2023-0144354 filed on Oct. 26, 2023, the disclosures of which are incorporated herein by reference in their entirety.

### BACKGROUND

### 1. Field of the Invention

The present invention relates to an artificial intelligence and machine learning methodology, and more particularly, to a multitask learning apparatus and method for performing simultaneous learning on heterogeneous sparse datasets which have small amounts of data and belong to different domains.

### 2. Discussion of Related Art

With the recent explosive growth of the bigdata market and technology, deep learning-based systems are advancing. Still, there are industrial fields in which it is difficult to acquire a sufficient amount of available data.

If it is difficult to directly provide training data sources or build infrastructure, we depend on small amounts of public or commercial data sources which are partially divided. However, if the amount of data is not sufficient, it is difficult to expect a level of inference performance that can be substantiated regardless of making the complexity of an artificial intelligence (AI) model higher. Also, even if a total amount of data is increased by collecting several datasets, it is not easy to use the datasets in an integrative manner because a data collection period of time, a data collection target, and environmental factors vary depending on dataset.

When the amount of training data is not sufficient as described above or holding data has a complex structure, such as dimensional images or natural language, a multitask learning technology may be introduced. Multitask learning is an AI methodology for improving performance for all given tasks by simultaneously learning several similar datasets. According to multitask learning, even if each dataset has a small size, such datasets are collected and used like one dataset for learning. Multitask learning has a structure of extracting a feature of data belonging to each task through a shared layer and then performing each individual task using a common feature extracted by separating as many learning layers as the number of tasks. Information obtained in the process of learning each task through such a model structure may also have a significant influence on improvement in the learning performance of another task.

However, there are roughly two technical problems in general multitask learning.

The first problem is a restriction that data to be learned in each task should exist in the same feature space. Feature vectors of data should have the same dimensions, and a configuration of features that may be presented by each feature vector, the range of values of the features, and the like should not vary depending on the task. This is because it is necessary to share the same network structure in a process of extracting a common feature from datasets, and forward propagation to a shared layer is impossible when data features are heterogeneous. It is difficult to expect a plurality of datasets collected in the real world to have the same structure and feature.

The second problem is that there is no way to determine whether a shared layer is actually involved in learning common features. Tasks may have actually very different data distributions or labeling criteria. In this case, a learning model is trained not to extract a common feature from data but in a direction for each individual task to competitively improve its own inference performance only. As a result, in some cases, learning of each dataset may degrade inference performance for an unrelated task. In particular, when there is a significant difference in learning difficulty between tasks, overfitting occurs on learning of a task of which a classification loss value can be easily reduced, resulting in imbalanced performance among tasks.

### SUMMARY OF THE INVENTION

The present invention is directed to providing a multitask learning method of compensating for performance degradation of a model caused by lack of data and ensuring performance improvement and balanced performance by simultaneously learning heterogenous and sparse datasets which have small amounts of data and belong to different domains. The present invention is also directed to providing an apparatus for performing such a multitask learning method.

Technical objectives of the present invention are given below.
1) In an existing multitask learning mechanism, it is not possible to learn datasets having different feature spaces in common.
2) In the case of learning different datasets, a shared layer cannot perform a function of extracting a common feature normally, or a difference in inference performance between tasks significantly increases accordingly.

To achieve the above purpose, the present invention proposes three techniques given below.
1) A data augmentation technique of generating a batch to simultaneously learn heterogeneous datasets having different feature spaces.
2) A technique of projecting heterogeneous datasets so that they may have similar feature spaces.
3) A technique of adjusting optimization strength of representation loss and task-specific loss to resolve imbalanced learning performance between a shared layer and each individual task inference layer.

According to an aspect of the present invention, there is provided a multitask learning apparatus for improving performance of learning heterogeneous sparse datasets, wherein the multitask learning apparatus includes a first layer configured to generate feature vectors by projecting training data pairs generated from different tasks to one feature space, a second layer configured to extract a common feature from the projected feature vectors, and a third layer configured to draw each individual inference from the extracted common feature. Here, the first layer and the third layer are task-specific layers, and the second layer is a layer shared between tasks. The first layer, the second layer, and the third layer perform forward propagation in one artificial neural network.

According to another aspect of the present invention, there is provided a multitask learning method performed in an artificial neural network including a first layer, a second layer, and a third layer, the multitask learning method comprising:

generating, by the first layer, feature vectors by projecting training data pairs generated for different tasks to one feature space; extracting, by the second layer, a common feature from the projected feature vectors; and drawing, by the third layer, each individual inference from the extracted common feature.

The foregoing solution will become more apparent through embodiments described below with reference to drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a configuration of a multitask learning apparatus and method for learning heterogeneous datasets according to one embodiment of the present invention;

FIG. 2 is a diagram illustrating data augmentation of generating an input data pair for learning heterogeneous datasets;

FIG. 3 is a diagram illustrating forward propagation for extracting individual features and a common feature;

FIG. 4 is a diagram illustrating a function of an independent classifier for performing each individual task;

FIG. 5 is a diagram illustrating a backpropagation process of multitask learning; and

FIG. 6 is a block diagram of a computer system that is the implementation basis of the present invention.

### DETAILED DESCRIPTION OF EXEMPLARY EMBODIMENTS

Hereinafter, exemplary embodiments of the present invention will be described in detail with reference to the accompanying drawings. Terminology used herein is for the purpose of describing the embodiments of the present invention and not for limiting the present invention. In the specification, singular forms include plural forms unless the content clearly indicates otherwise. Also, the terms “comprise,” “comprising,” and the like used herein do not preclude the presence or addition of one or more components, steps, operations, and/or elements other than stated components, steps, operations, and/or elements.

An apparatus and method for performing “multitask learning for improving learning performance of heterogeneous sparse datasets” according to embodiments of the present invention may be summarized as follows.
1) An input data pair that may be simultaneously learned is generated from task-specific data.
2) The generated input data pair is projected to one feature space.
3) A common feature is extracted by passing the projected feature vector pair through a common layer.
4) Each individual inference is accomplished by distributing each feature vector passed through the shared layer to an inference layer corresponding to the relevant task.

The computations 2) to 4) may be sequentially performed through a forward propagation process in one artificial neural network model. The artificial neural network may be a deep neural network including one layer or two or more layers. The artificial neural network may be a fully-connected neuron, a convolutional neural network (CNN), a recurrent neural network (RNN), or a neural network having a similar structure thereto.

In the present invention, the tasks may be those related to classification, recurrence, generation, and the like.

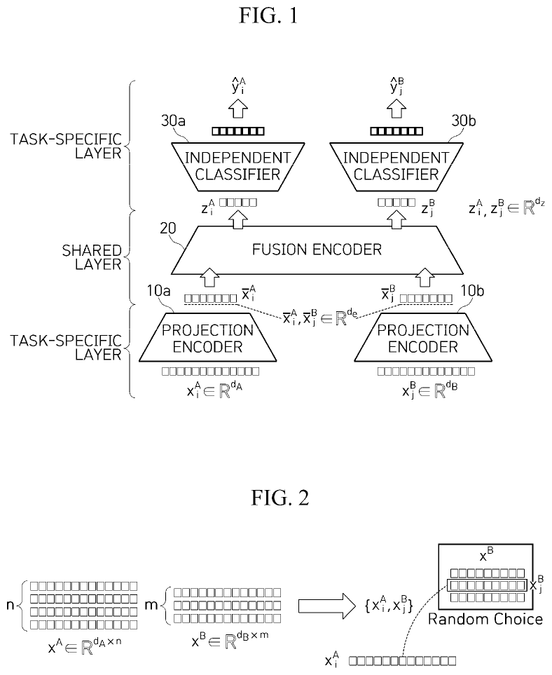

FIG. 1 is a block diagram of a neural network that is associated with a multitask learning apparatus and method for improving learning performance of heterogeneous sparse datasets according to one embodiment of the present invention.

In the neural network illustrated in FIG. 1, a first layer, a second layer, and a third layer are stacked in three stages from bottom to top. In FIG. 1, two types of tasks A and B are described as examples, but the present invention is applicable to learning of three or more types of tasks.

Input training data is propagated forward to the first, second, and third layers. The first layer may include projection encoders 10a and 10b. The second layer may include a fusion encoder 20. The third layer may include independent classifiers 30a and 30b. Here, the fusion encoder 20 is a layer shared by tasks (shared layer), and the projection encoders 10a and 10b and the independent classifiers 30a and 30b are layers that separately perform computation for tasks (task-specific layers).

First, the projection encoders 10a and 10b apply individual computation to data samples xᵢ^{A}, xⱼ^{B} included in different tasks so that all data is projected to the same feature space.

FIG. 1 illustrates that data xᵢ^{A}, xⱼ^{B} having different structures both have the form of a one-dimensional vector. However, according to the present invention, it is possible to learn high-dimensional data such as image information. When results of the projection encoders 10a and 10b are x̅ᵢ^{A}, x̅ⱼ^{B}, the two feature vectors are required to have the same size as a constant dₑ defined by a user.

Subsequently, the fusion encoder 20 applies the same computation to all the data regardless of task types to calculate feature vectors zᵢ^{A}, zⱼ^{B} reflecting a common feature between the data.

Finally, the independent classifiers 30a and 30b classify the obtained feature vectors zᵢ^{A}, zⱼ^{B} into task groups to which the input data have belonged and perform individual layer computation on each task to separately infer final results ŷᵢ^{A}, ŷⱼ^{B}. In some embodiments, the independent classifiers 30a and 30b may determine which of 0 to 9 correspond to different types of numerical images.

The multitask learning structure schematically described above according to exemplary embodiments of the present invention will be described in detail below.

Data to be learned has different forms, amounts, and feature value distributions. Description will be made again on the basis of the tasks A and B illustrated above. Given datasets D_{A}={xᵢ^{A}, yᵢ^{A}}ᵢ₌₁ⁿ and D_{B}={xⱼ^{B}, yⱼ^{B}}ⱼ₌₁^{m} include n and m pieces of data, respectively. To ensure heterogeneity between the datasets, input data x^{A}∈ [symbol] ^{d}^{_{A}}^{×n} and x^{B}∈ [symbol] ^{d}^{_{B}}^{×m} is required to satisfy a condition [symbol] ^{d}^{_{A}}^{×n}≠ [symbol] ^{d}^{_{B}}^{×m} that feature spaces are different. In some embodiments, the importance between classes and a distribution of feature values may vary depending on a dataset.

In this way, a process of projecting each piece of data to the same feature space is performed first to learn datasets having different structures through one model. Since it is necessary for the projection encoders 10a and 10b to simultaneously perform task-specific learning, samples x^{A} and x^{B} of the two datasets are paired first. This operation may be performed using a data augmentation technique.

FIG. 2 is a diagram illustrating the concept of data augmentation of generating a data pair for training a model from heterogeneous datasets. Since each dataset has a different number of samples and there is no direct correlation between a k^{th} piece of data of x^{A} and a k^{th} piece of data of x^{B}, pieces of data randomly extracted from each the datasets are paired. This is performed so that all data of each dataset is included in at least one input data pair. In other words, as shown in FIG. 2, each data sample xᵢ^{A} is paired with a sample xⱼ^{B} which is sampled with replacement from the other dataset. In the above example, input data pairs {xᵢ^{A}, xₜ₍ᵢ₎^{B}}ᵢ₌₁ⁿ (t(i) is an integer randomly extracted from 1 to n) may be obtained from n samples belonging to a dataset A, and on the other hand, input data pairs {xₛ₍ⱼ₎^{A}, xⱼ^{B}}ⱼ₌₁^{m} (s(j) is an integer randomly extracted from 1 to m) may be obtained from m samples belonging to a dataset B. As a result, the model has (n+m) input data pairs obtained by integrating the two types of input datasets as a training dataset.

Subsequently, the input data pairs generated through the data augmentation process are passed through the projection encoders 10a and 10b to extract individually compressed feature vectors. The extracted feature vector is propagated forward to the layer called the fusion encoder 20 which is shared by all tasks.

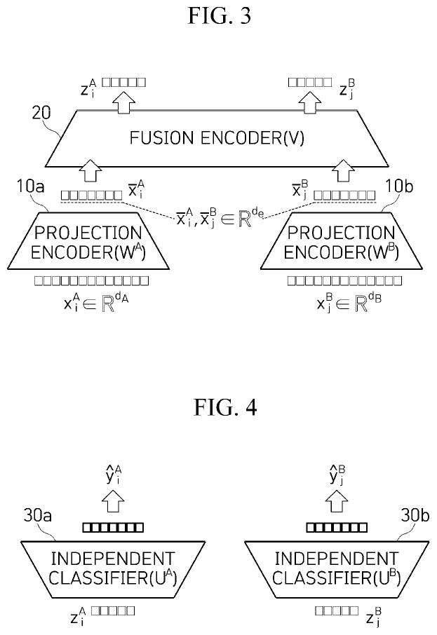

FIG. 3 is a diagram illustrating a process in which an input data pair is sequentially passed through the projection encoders 10a and 10b and the fusion encoder 20 to calculate latent vectors zᵢ^{A} and zⱼ^{B} from which individual features and a common feature are extracted. The projection encoders 10a and 10b have a purpose of unifying feature spaces for reducing dimensions of task input data and training the fusion encoder 20. The projection encoders 10a and 10b calculate intermediate results x̅ᵢ^{A}=W^{A}xᵢ^{A} and x̅ⱼ^{B}=W^{B}xⱼ^{B} using individual weight matrices W^{A}.W^{B} separately allocated to the tasks. On the other hand, the fusion encoder 20 calculates zᵢ^{A}=Vx̅ᵢ^{A} and zⱼ^{B}=Vx̅ⱼ^{B} by applying the same weight matrix V to the intermediate results.

The final layer of the multitask learning apparatus of the present invention includes a neural network for individual task inference.

FIG. 4 is a diagram illustrating a process of reallocating a latent vector extracted through the fusion encoder 20 to an inference task and performing inference. Inference results ŷᵢ^{A}=U^{A}zᵢ^{A} and ŷⱼ^{B}=U^{B}zⱼ^{B} are finally obtained through the independent classifiers 30a and 30b separately assigned to the tasks. Here, weight parameters of the independent classifiers 30a and 30b are not shared with each other.

Although FIG. 4 illustrates that both tasks are of Classification, other tasks, such as Recurrence or Generation, may also be used, in other embodiments.

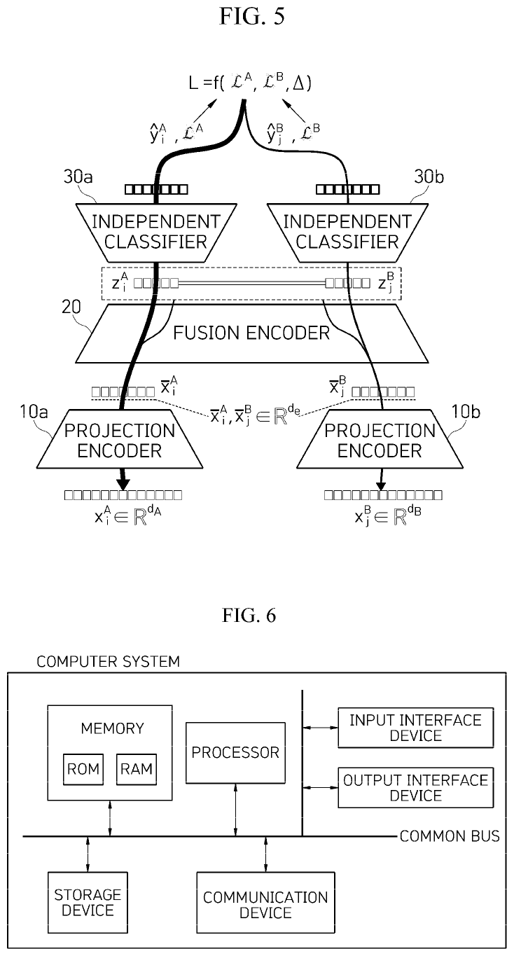

Backpropagation for adjusting optimization strength of multitask learning according to the present invention will be described below. With this, it is possible to correct an imbalance in learning performance between a shared layer and each individual task inference layer. A loss function and a backpropagation process for this purpose are shown in FIG. 5.

In the present invention, a multitask learning model uses two loss functions for backpropagation. The first loss function is the sum of task-specific inference errors. In FIG. 5, when inference errors for the two datasets A and B are [symbol] ^{A}, [symbol] ^{B}, respectively, an overall inference error is expressed as shown in Expression 1 below.

$$α \cdot CE ( {y}^{A} , {U}^{A} {VW}^{A} {x}^{A} ) + ( 1 - α ) \cdot CE ( {y}^{B} , {U}^{B} {VW}^{B} {x}^{B} ) \qquad [ Expression 1 ]$$

$$where α = \frac{\vert {D}_{A} \vert}{\vert {D}_{A} \vert + \vert {D}_{B} \vert}$$

In the above expression, CE is a cross entropy function, and α is a ratio of the dataset A to the total amount of data.

The second loss function is a pairwise representation loss Δ. This loss function Δ represents how similar feature vectors that are calculated by the fusion encoder 20 are independent of task type. Also, this loss function is a measure of how similar feature spaces the projection encoders 10a and 10b have projected heterogeneous datasets to. Further, this loss function is a measure of how appropriately the fusion encoder 20 has extracted the common feature of the projected vectors x̅ᵢ^{A}, x̅ⱼ^{B} obtained through the projection encoders 10a and 10b.

The pairwise representation loss may be expressed as shown in Expression 2 below.

$$Δ ( {z}^{A} , {z}^{B} ) = \frac{δ ( {z}^{A} , {z}^{B} )}{1 + δ ( {z}^{A} , {z}^{B} )} \qquad [ Expression 2 ]$$

$$δ ( {z}^{A} , {z}^{B} ) = \frac{1}{\vert {z}^{A} \vert \cdot \vert {z}^{B} \vert} {\sum }_{p ∈ {z}^{A}} {\sum }_{q ∈ {z}^{B}} exp ( - \frac{{‖ p - q ‖}^{2}}{2 {σ}^{2}} )$$

In Expression 2, similarity of latent vectors between the tasks is expressed as a Gaussian distance such as δ. The pairwise representation loss Δ represents an overall similarity as a value between 0 and 1 using δ. A closer to 0 represents that the similarity of the latent vectors calculated from different tasks is high, and when the similarity becomes low, Δ has a value close to 1.

Backpropagation is performed using a final loss function, which is a combination of the two loss functions used by the multitask learning model according to an exemplary embodiment of the present invention, as shown in Expression 3 below.

$${min}_{W , V , U} α \cdot CE ( {y}^{A} , {U}^{A} {z}^{A} ) + ( 1 - α ) \cdot CE ( {y}^{B} , {U}^{B} {z}^{B} ) + β \cdot Δ ( {z}^{A} , {z}^{B} ) \qquad [ Expression 3 ]$$

$$where α = \frac{\vert {D}_{A} \vert}{\vert {D}_{A} \vert + \vert {D}_{B} \vert} ,$$

β=constant, z^{A}=VW^{A}x^{A}, z^{B}=VW^{B}x^{B}

The multitask learning apparatus and method described above may be implemented on the basis of a computer system illustrated in FIG. 6.

The computer system shown in FIG. 6 may include at least one of a processor, a memory, an input interface device, an output interface device, and a storage device that communicate through a common bus. The computer system may also include a communication device that is connected to a network. The processor may be a central processing unit (CPU) or a semiconductor device that executes instructions stored in the memory or storage device. The communication device may transmit or receive a wired signal or wireless signal. The memory and storage device may include various forms of volatile or non-volatile storage media. The memory may include a read-only memory (ROM) and a random-access memory (RAM). The memory may be inside or outside the processor and connected to the processor through one of various well-known devices.

Therefore, the present invention may be implemented as a method performed by a computer or may be implemented as a non-transitory computer-readable medium in which computer-executable instructions are stored. In an embodiment, when executed by the processor, the computer-executable instructions may perform a method according to at least one aspect described herein.

Also, a method according to the present invention may be implemented in the form of program commands that are executable by various computing devices and recorded on a computer-readable recording medium. The computer-readable recording medium may include program commands, data files, data structures, and the like solely or in combination. The program commands recorded on the computer-readable recording medium may be specially designed and configured for an embodiment of the present invention or may be known and available to those of ordinary skill in the field of computer software. The computer-readable recording medium may include a hardware device configured to store and execute program commands. Examples of the computer-readable recording medium may be magnetic media, such as a hard disk, a floppy disk, and magnetic tape, optical media, such as CD-ROM and a digital versatile disc (DVD), magneto-optical media, such as a floptical disk, a ROM, a RAM, a flash memory, and the like. The program commands may include not only machine-language code generated by a compiler but also high-level language code which is executable by a computer through an interpreter and the like.

Compared to the related art, the technology proposed by the present invention has the following advantages.
1) According to the present invention, ahead of a shared layer, a projection encoder is added for each individual task, and data augmentation is performed by randomly binding samples of datasets, in order to learn the datasets. Accordingly, several datasets having different numbers of data features, different structures, and different distributions can be simultaneously learned by a single model.
2) Due to the first advantage, the present invention has fewer restrictions on selecting datasets for common learning than the related art. Accordingly, various datasets can be collected so that learning can be performed using ample data features. Therefore, high performance can be expected even when a task having a small amount of data is included.
3) According to the related art, learning is performed in a biased manner using a particular selection from several datasets to be learned. On the other hand, according to the present invention, the distance between the groups is obtained, by a shared layer, from the intermediate results calculated from each the task and is optimized by employing a loss function. Therefore, learning is prevented from being biased and increasing the performance of only some tasks.

Embodiments for concretely implementing the spirit of the present invention have been described above. However, the technical scope of the present invention is not limited to the above-described embodiments and drawings and is determined by reasonable interpretation of the claims.

What is claimed is:

1. A multitask learning apparatus comprising:
a first layer configured to generate feature vectors by projecting training data pairs generated for different tasks to one feature space;
a second layer configured to extract a common feature from the projected feature vectors; and
a third layer configured to draw each individual inference from the extracted common feature,
wherein the first layer and the third layer are task-specific layers, and the second layer is a layer shared between tasks, and
the first layer, the second layer, and the third layer perform forward propagation in one artificial neural network.

2. The multitask learning apparatus of claim 1, wherein the first layer includes projection encoders.

3. The multitask learning apparatus of claim 1, wherein the first layer uses individual weight matrices separately allocated to the tasks to generate the feature vector.

4. The multitask learning apparatus of claim 1, wherein the second layer includes a fusion encoder.

5. The multitask learning apparatus of claim 1, wherein the second layer uses one weight matrix to extract the common feature.

6. The multitask learning apparatus of claim 1, wherein the third layer includes independent classifiers.

7. The multitask learning apparatus of claim 1, wherein the training data pairs are generated using a data augmentation technique.

8. The multitask learning apparatus of claim 1, wherein task-specific inference errors and pairwise representation losses are used as loss functions for backpropagation of the artificial neural network.

9. A multitask learning method performed in an artificial neural network including a first layer, a second layer, and a third layer, the multitask learning method comprising:
generating, by the first layer, feature vectors by projecting training data pairs generated for different tasks to one feature space;
extracting, by the second layer, a common feature from the projected feature vectors; and
drawing, by the third layer, each individual inference from the extracted common feature.

10. The multitask learning method of claim 9, wherein the first layer generates the feature vector using individual weight matrices separately allocated to the tasks.

11. The multitask learning method of claim 9, wherein the second layer uses one weight matrix to extract the common feature.

12. The multitask learning method of claim 9, wherein the training data pairs are generated using a data augmentation technique.

13. The multitask learning method of claim 12, wherein, according to the data augmentation technique, pieces of data randomly extracted from task datasets are paired, and all data of each dataset is included in at least one of the training data pairs.

14. The multitask learning method of claim 9, further comprising performing backpropagation in the artificial neural network using task-specific inference errors and pairwise representation losses.
